(19) United States
(12) Patent Application Publication
(10) Pub. No.: US 2012/0148194 A1
(43) Pub. Date: Jun. 14, 2012

(54) LIGHT GUIDING DEVICE

(76) Inventor: LI-CHEN WANG, TAINAN CITY (TW)

(21) Appl. No.: 13/397,847

(22) Filed: Feb. 16, 2012

Related U.S. Application Data
(63) Continuation-in-part of application No. 12/752,457, filed on Apr. 1, 2010.

(30) Foreign Application Priority Data
Jun. 24, 2009 (TW) 098211370

(51) Int. Cl. G02B 6/26

(52) U.S. Cl. 385/39

(57) ABSTRACT

A light guiding device includes an optical fiber body that extends along a longitudinal direction and that has an optical fiber center, at least three reflectors that are buried in the optical fiber body and that extend along the longitudinal direction, and a refraction layer that covers around the optical fiber body. The reflectors are spaced apart from an external surface of the optical fiber body, and surround equiangularly the optical fiber center of the optical fiber body.

### CROSS-REFERENCE TO RELATED APPLICATION

This application is a continuation-in-part (CIP) of co-pending U.S. patent application Ser. No. 12/752,457, filed on Apr. 1, 2010.

### BACKGROUND OF THE INVENTION

1. Field of the Invention

The present invention relates to a light guiding device, more particularly to a light guiding device that enhances light intensity and uniformity by means of reflection elements.

2. Description of the Related Art

Generally, optical fibers have a plurality of advantages such as resistance to damages, impervious to water, high temperature resistance, and low heat generation. Thus optical fibers have been widely used in light and signal transmission. Moreover, the optical fibers provide good flexibility, plasticity and easy-shaped and modified appearance so that it is also widely applied to billboards, exit signs etc for illumination.

However, after light emitted from a light source into one end of the optical fiber, part of the optical fiber near the light source provides light with highest intensity. The light intensity generally decreases with increasing distance from the light source and nearly no light at the rear end of the optical fiber. When the optical fibers are used in ornaments or billboards, they have shortcomings of insufficient and non-uniform light intensity. Once the optical fibers are bent or curved, the light attenuation is more severe. The insufficient and non-uniform light intensity of the optical fiber cause a concern for the safety once the optical fiber is used in the public safety field such as exit signs.

Thus there is a need to have a novel design of the optical fiber that overcomes shortcomings of the optical fiber available now such as insufficient intensity and non-uniformity light.

Referring to FIG. 1, U.S. Pat. No. 6,278,827 B1 discloses a light transmission tube 9 that comprises a core section 91, a transparent tubular clad 92 that covers around the core section 91, and three reflecting layers 93a, 93b, 93c that are spaced apart from one another. Each of the reflecting layers 93a, 93b, 93c has a reflecting surface 931 that faces the core section 91, and an attachment surface 932 that is attached to the transparent tubular clad 92. The reflecting layer 93b is angularly spaced apart from the reflecting layer 93c by 90 degrees, while the reflecting layer 93a is angularly spaced apart from each of the reflecting layers 93c, 93b by 135 degrees. That is, the reflecting layers 93a, 93b, 93c surrounds the center of the core section 91 in a non-equiangular manner so that the light transmission tube 9 has more reflection structures.

However, since the reflecting layers 93a, 93b, 93c are all attached to the transparent tubular clad 92, light inside the light transmission tube 9 can not transmit outwardly through the regions of the transparent tubular clad 92 to which the reflecting layers 93a, 93b, 93c are attached no matter how the light is refracted and reflected. Therefore, the light transmission tube 9 would have three dark regions that block the light transmission, thereby resulting in a non-uniform distribution of light.

### SUMMARY OF THE INVENTION

Therefore, the object of the present invention is to provide a light guiding device that has an improved uniformity so as to enhance the convenience for the application thereof.

Accordingly, a light guiding device of the present invention comprises: an optical fiber body that extends along a longitudinal direction and that has an optical fiber center; three or four reflectors that are buried in the optical fiber body and that extend along the longitudinal direction; and a refraction layer that covers around the optical fiber body. The reflectors are spaced apart from an external surface of the optical fiber body, and surround equiangularly the optical fiber center of the optical fiber body.

### BRIEF DESCRIPTION OF THE DRAWINGS

Other features and advantages of the present invention will become apparent in the following detailed description of the preferred embodiments with reference to the accompanying drawings, of which:

FIG. 1 is a cross-sectional view of a light transmission tube disclosed in U.S. Pat. No. 6,278,827 B1;

FIG. 2 is a fragmentary perspective view of a first preferred embodiment of a light guiding device according to the present invention;

FIG. 3 is a cross-sectional view of the first preferred embodiment;

FIG. 4 is a schematic view illustrating propagation of light reflected from a first reflector of the first preferred embodiment;

FIG. 5 is a view similar to FIG. 4, but illustrating propagation of light reflected from a second reflector of the first preferred embodiment;

FIG. 6 is another view similar to FIG. 9, but illustrating propagation of light reflected by a third reflector of the first preferred embodiment;

FIG. 7 is a cross-sectional view of a second preferred embodiment of the light guiding device according to the present invention;

FIG. 8 is a cross-sectional view of a third preferred embodiment of the light guiding device according to the present invention;

FIG. 9 is a schematic view illustrating propagation of light reflected from a first reflector of the third preferred embodiment; and

FIG. 10 is another schematic view similar to FIG. 9, but illustrating propagation of light reflected from a third reflector of the third preferred embodiment.

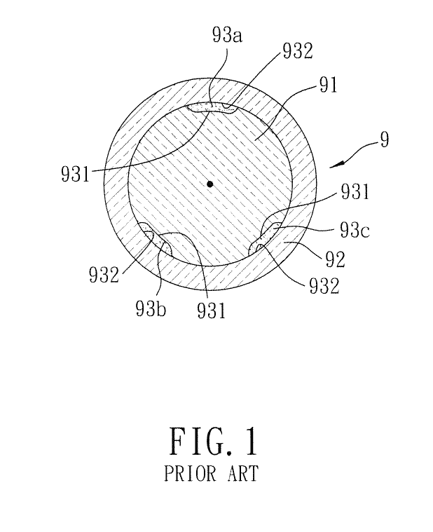

### DETAILED DESCRIPTION OF THE PREFERRED EMBODIMENTS

Before the present invention is described in greater detail, it should be noted that like components are assigned the same reference numerals throughout the following disclosure.

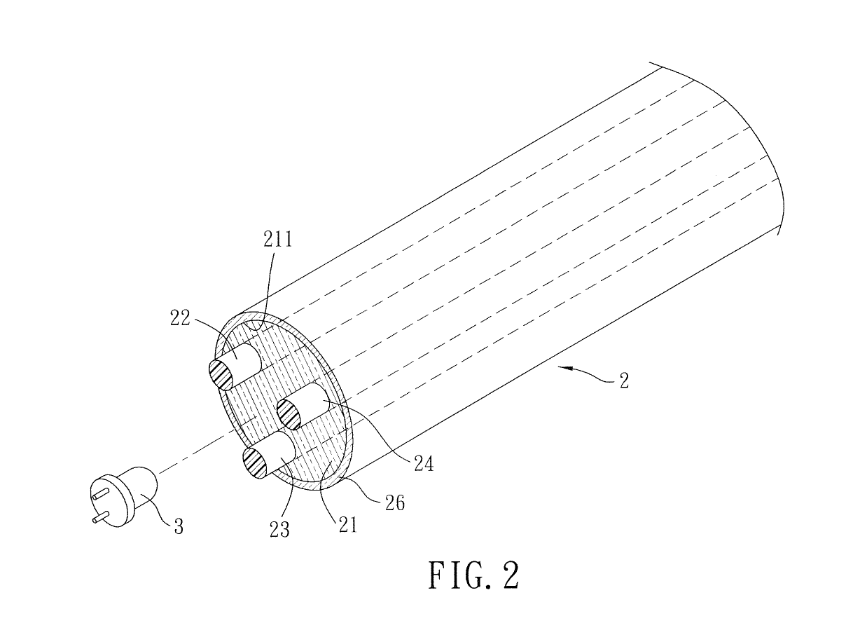

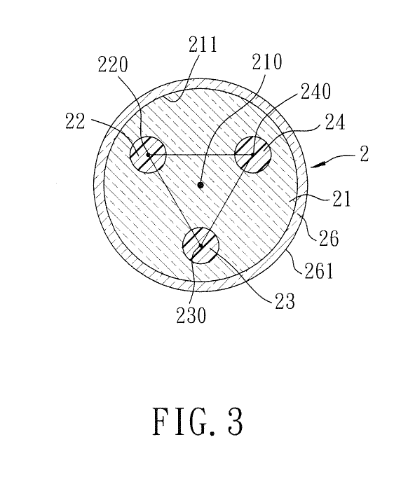

Referring to FIGS. 2 and 3, a first preferred embodiment of a light guiding device 2 of the present invention is adapted for guiding light emitted from a light emitting element 3. The light guiding device 2 comprises an optical fiber body 21, first, second and third reflectors 22, 23, 29 that are buried in the optical fiber body 21, and a refraction layer 26 that covers around the optical fiber body 21. In this embodiment, the optical fiber body 21 is a transparent solid plastic strip with a circular cross-section, and may be made of polystyrene (PS), polycarbonate (PC), polymethyl methacrylate (PMMA), etc. The optical fiber body 21 has an external surface 211 that surrounds an optical fiber center 210 of the optical fiber body 21.

The first reflector 22, the second reflector 23 and the third reflector 24 are all opaque solid plastic strips and are made of opaque PMMA in this embodiment. The first reflector 22, the second reflector 23 and the third reflector 24 surround equiangularly the optical fiber center 210 of the optical fiber body 21. Specifically, in this embodiment, the first reflector 22 is circular in cross-section and has a center 220, the second reflector 23 is circular in cross-section and has a center 230, and the third reflector 29 is circular in cross-section and has a center 240. The diameters of the first reflector 22, the second reflector 23 and the third reflector 24 are equal, and the centers 220, 230, 240 are located on apexes of an imaginary equilateral triangle. In addition, the first reflector 22, the second reflector 23 and the third reflector 24 are spaced apart from the external surface 211 of the optical fiber body 21 (i.e., the reflectors 22, 23, 29 are not in contact with the external surface 211 of the optical fiber body 21)

In this embodiment, the refraction layer 26 is made of ployvinylidene fluoride, and has a light emitting face 261.

While the light guiding device 2 is in use, the light emitted from the light emitting element 3 is transmitted from one end to the other end of the light guiding device 2, and is projected uniformly and outwardly through the light emitting face 261 of the refraction layer 26 by virtue of refraction and reflection of the optical fiber body 21, the first reflector 22, the second reflector 23, the third reflector 24 and the refraction layer 26 during the light transmission process. Since the first reflector 22, second reflector 23 and third reflector 24 are buried in the optical fiber body 21 and are not in contact with the external surface 211 of the same, the light is reflected by the first reflector 22, the second reflector 23 and the third reflector 29. By virtue of the equiangular arrangement of the first, second and third reflectors 22, 23, 24, dark regions in the optical fiber body 21 that may be generated due to the interference among the first, second and third reflectors 22, 23, 24 can be eliminated.

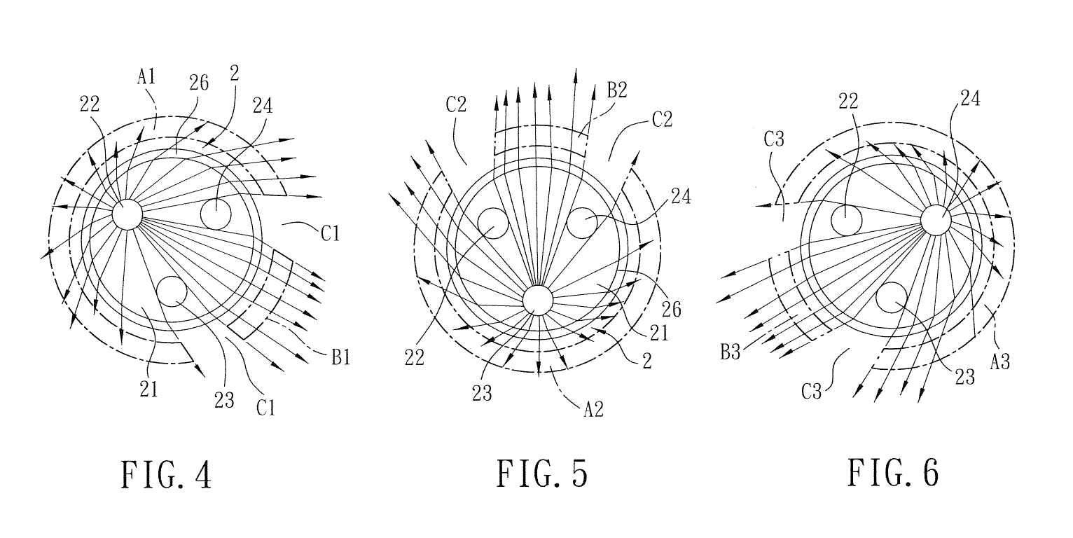

Referring to FIGS. 9, 5 and 6 the light reflected by the first reflector 22 would be blocked by the second reflector 23 and the third reflector 24. Therefore, a large light emitting region A1, a small light emitting region B1, and two dark regions C1 at angularly opposite sides of the small light emitting region B1 would be generated (see FIG. 4). Similarly, the light reflected by the second reflector 23 would generate a large light emitting region A2, a small light emitting region B2, and two spaced-apart dark regions C2 (see FIG. 5), while the light reflected by the third reflector 24, would generate a large light emitting region A3, a small light emitting region B3, and two spaced-apart dark regions C3 (see FIG. 6). The dark regions C1 coincide with the large light emitting regions A2, A3, while the dark regions C2 coincide with the large light emitting regions A1, A3, and the dark regions C3 coincide with the large light emitting regions A1, A2. Therefore, in this embodiment, the presence of the first, second and third reflectors 22, 23, 24 not only increases the light intensity of the light guiding device 2, but also improves the light uniformity of the light guiding device 2 by complementing the dark regions C1, C2, C3 with the large light emitting regions A1, A2, A3. Thus, the light guiding device 2 has a novel structure, as well as an improved light uniformity and convenience in use.

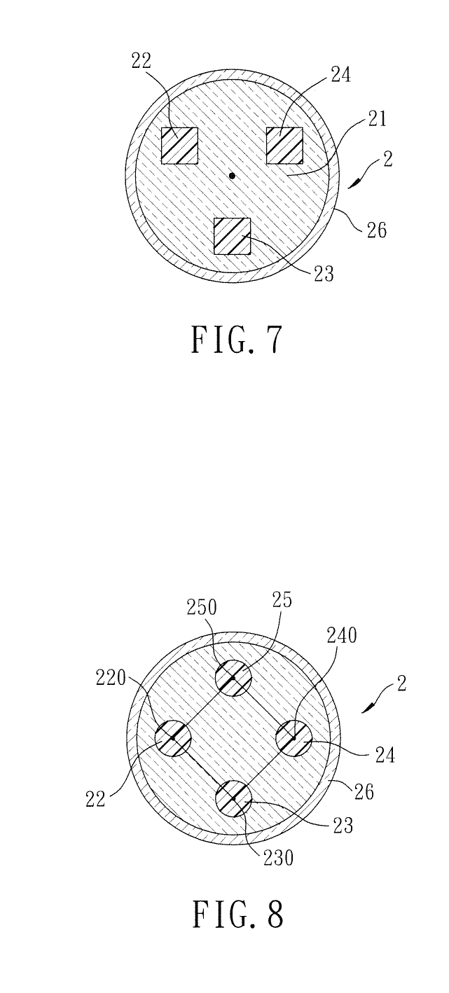

Referring to FIG. 7, a second preferred embodiment of a light guiding device 2 according to the present invention is shown to have a structure similar to that of the first embodiment, and comprises an optical fiber body 21, a first reflector 22, a second reflector 23, a third reflector 24, and a refraction layer 26. The second preferred embodiment differs from the first preferred embodiment in that the first reflector 22, second reflector 23 and third reflector 24 are rectangular in cross-section. The second preferred embodiment has the same advantages as those of the first preferred embodiment.

Referring to FIG. 8, a third preferred embodiment of a light guiding device 2 according to the present invention is shown to have a structure similar to that of the first preferred embodiment except that the third preferred embodiment further includes a fourth reflector 25 that has a center 250. The first to the fourth reflectors 22-25 are circular in cross section, and the centers 220 to 250 are located on apexes of an imaginary square.

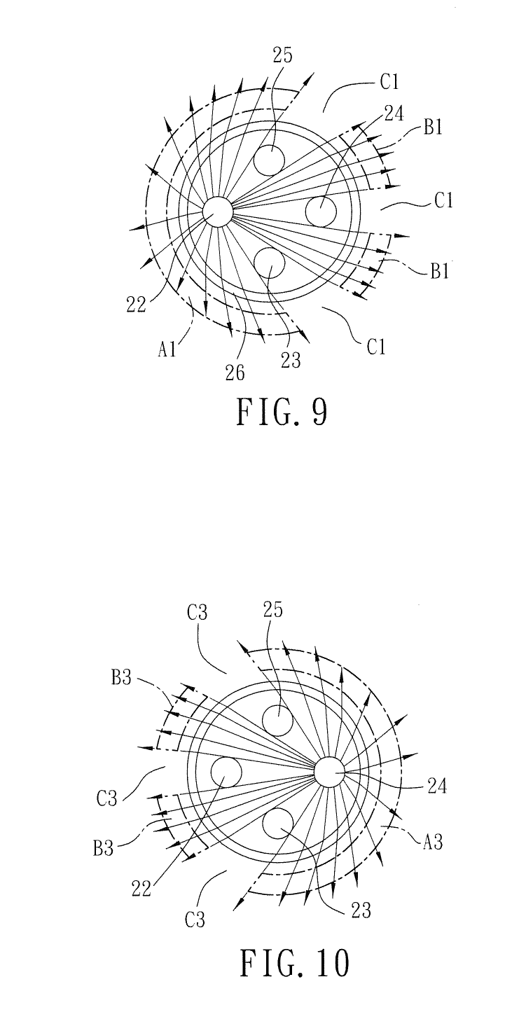

Referring to FIGS. 9 and 10, when the light guiding device 2 of the third preferred embodiment is in use, the second to the fourth reflectors 23-25 would interfere the light reflection of the first reflector 22, and generate a large light emitting region A1, two small light emitting regions B1, and three dark regions C1 outside the refraction layer 26 (see FIG. 9). Also, the light reflected by the third reflector 29 would be blocked by the first reflector 22, the second reflector 23 and the fourth reflector 25 to generate a large light emitting region A3, two small light emitting regions B3, and three dark regions C3 (see FIG. 10). Since the dark regions C1 coincide with the large light emitting region A3 and the dark regions 03 coincide with the large light emitting region A1, the light reflection of the first reflector 22 is complementary to that of the third reflector 29. Similarly, the light reflection of the second reflector 23 is complementary to that of the fourth reflector 25. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light guiding device, comprising:
an optical fiber body that extends along a longitudinal direction and that has an optical fiber center and an external surface;
three reflectors that are buried in said optical fiber body and that extend along the longitudinal direction, said reflectors being spaced apart from said external surface of said optical fiber body and surrounding equiangularly said optical fiber center of said optical fiber body; and
a refraction layer that covers around said optical fiber body.

2. The light guiding device as claimed in claim 1, wherein each of said reflectors has a center, said centers of said reflectors being located on apexes of an imaginary equilateral triangle.

3. The light guiding device as claimed in claim 2, wherein said reflectors are circular in cross-section.

4. The light guiding device as claimed in claim 3, wherein said optical fiber body is circular in cross-section.

5. The light guiding device as claimed in claim 2, wherein said reflectors are rectangular in cross-section.

6. The light guiding device as claimed in claim 5, wherein said optical fiber body is circular in cross-section.

7. A light guiding device, comprising:
an optical fiber body that extends along a longitudinal direction and that has an optical fiber center and having an external surface;
four reflectors that are buried in said optical fiber body and that extend along the longitudinal direction, said reflectors being spaced apart from said external surface of said optical fiber body and surrounding equiangularly said optical fiber center of said optical fiber body; and
a refraction layer that covers around said optical fiber body.

8. The light guiding device as claimed in claim 7, wherein each of said reflectors has a center, said centers of said reflectors being located on apexes of an imaginary square.

9. The light guiding device as claimed in claim 8, wherein said reflectors are circular in cross-section.

10. The light guiding device as claimed in claim 9, wherein said optical fiber body is circular in cross-section.
